(19) United States
(12) Patent Application Publication
(10) Pub. No.: US 2021/0323728 A1
(43) Pub. Date: Oct. 21, 2021

(54) BREAD TRAY MERCHANDISER BARRIER

(71) Applicant: ORBIS Corporation, Oconomowoc, WI (US)

(72) Inventors: Eric P. May, Canton, OH (US); Edward L. Stahl, Bullard, TX (US)

(21) Appl. No.: 17/234,261

(22) Filed: Apr. 19, 2021

Related U.S. Application Data
(60) Provisional application No. 63/013,072, filed on Apr. 21, 2020.

(51) Int. Cl. B65D 25/20; B65D 1/34; B65D 25/54

(52) U.S. Cl. CPC B65D 25/20; B65D 25/54; B65D 1/34

(57) ABSTRACT

The invention is directed to a reusable bread tray merchandiser barrier that is connectable to a bread tray having a merchandiser window. The barrier includes a plastic first panel for blocking the merchandiser window, and a connector for connecting the barrier to the bread tray. The connector can include a first hook portion for engaging a lower front wall edge of the bread tray and a second hook portion for engaging an upper front wall edge of the bread tray.

### CROSS-REFERENCE TO RELATED APPLICATIONS

The present invention claims priority to and the benefit of U.S. Provisional Patent Application No. 63/013,072 filed Apr. 21, 2020, the contents of which are incorporated herein by reference and made a part hereof.

FEDERALLY SPONSORED RESEARCH OR DEVELOPMENT

N/A

### FIELD OF THE INVENTION

The present invention is generally related to a barrier that can be attached to a bread tray having a merchandiser window in a side wall of the tray to block the window.

### DESCRIPTION OF THE PRIOR ART

Historically, bread trays for transporting bread and other similar products, have a “merchandiser window” on one wall of the tray. The merchandiser window allows for inspection of the product and serves as a means for removing product from the tray when it is stacked in a column configuration of like trays. While this merchandiser window serves its intended purpose, it does create unintended consequences such as smaller products potentially falling out of the tray during shipping from the bread manufacturer to the grocery store. Bread manufacturers often will accept that some product will be damaged or lost. In some instances, the manufacturer or transporter will place cardboard sleeves or inserts into the tray in front of the merchandiser window to prohibit product from falling out. However, such cardboard inserts are not reusable after one use and must be replaced.

The present invention provides a reusable solution that can be connected to a bread tray for blocking the merchandiser window when desired. The solution can be permanently connected to the tray or remove-ably connected.

### SUMMARY OF THE INVENTION

The present invention is directed to a plastic, reusable, bread tray merchandiser window barrier that can be connected to a bread tray. The barrier can be permanently attached to the tray, or it can be remove-ably connected. The barrier includes a portion that blocks or partially blocks the merchandiser window to stop product from failing out of the tray, particularly in a stacked configuration.

In accordance with one aspect of the invention, a bread tray merchandiser window barrier is provided. The barrier comprises a first plastic panel configured to block at least a portion of a merchandiser's window of a bread tray. The barrier also includes a connector extending from the first panel to enable connection of the first panel to the bread tray.

The connector can include a first lower hook extending downward from the first panel to engage a lower edge of a front wall of the bread tray. The connector can also include a second lower hook spaced from the first hook extending downward from the first panel to engage the lower edge of the front wall of the bread tray. Additionally, the connector can include a first interior hook extending outward from a first side of the first panel to engage an upper edge of the front wall of the bread tray. The connector can also include a second interior hook spaced from the first interior hook extending outward from the first side of the first panel to engage the upper edge of the front wall of the bread tray.

The first panel can span from a first side of the merchandizer window of the bread tray to a second side of the merchandizer window of the bread tray. The first panel can include a plurality of flanges extending outward from a second side of the first panel. The first panel can also include a first side wall clasp extending outward on a first side portion of the first panel and a second side wall clasp extending outward on a second side portion of the first panel.

The barrier can further include a ledge extending outward from a lower edge of the first panel. The ledge is configured to rest on an upper edge of the front wall of the bread tray.

In one form, the connector can include a plurality of protrusions extending downward from the first panel for engagement with a bottom surface of the bread tray. The bread tray typically includes a lattice-like bottom floor or surface having openings which can interact with the protrusions of the barrier.

In some instances, the barrier might only partially block the merchandiser window. In this regard, the first panel can extend part way from a first side of the merchandiser window of the bread tray toward a second side of the merchandiser window of the bread tray. The barrier can also include a second panel that extends part way from the second side of the merchandiser window of the bread tray toward the first side of the merchandiser window of the bread tray. A gap (smaller than the original merchandiser window) can exist between the first panel and the second panel. A portion of the connector can extend downward from the first panel and/or the second panel.

The barrier can be formed from an injection molded plastic. Other similar or suitable materials can also be used.

In one form, the barrier can be formed having a hinge element between the first panel and the connector. The hinge allows a user to pivot the barrier either inward or outward (depending on the positioning of the hinge) to provide access to the interior of the tray when in a stacked configuration.

In accordance with another aspect of the invention, a bread tray merchandiser window barrier is provided comprising a horizontal ledge, and a generally rectangular panel extending upward from the horizontal ledge. The barrier also includes a first hook portion extending downward from a first edge of the horizontal ledge where the first hook portion is configured to engage a lower edge of a front wall of a bread tray, and a second hook portion extending downward from a second edge of the horizontal ledge where the second hook portion is configured to engage an upper edge of the front wall of the bread tray.

The barrier can also include a plurality of flanges extending outward from a first side surface of the rectangular panel. The barrier can also have a centrally located gap portion in the rectangular panel. Moreover, the barrier can also include a first side wall clasp extending outward on a first side portion of the rectangular panel and a second side wall clasp extending outward on a second side portion of the rectangular panel.

In accordance with one aspect of the invention, the barrier could be pressed into the bread tray and held via snap locks. In another aspect, the barrier can be pressed into the bread tray and held via spring locks. In yet another aspect, the barrier can include a retainer plate that is hingedly connected to the bread tray (e.g., to the floor of the tray), and can be rotated to a blocking position for use and rotated back (e.g., to the floor) when not in use. In yet another aspect, the barrier can be connected to a bail arm and would be rotated up for use and rotated down for non-use or stored position.

The barrier can be permanently connected to the bread tray by one or more of the methods/structures described or suggested herein, or can be temporarily (i.e., remove-ably) held in the bread tray.

In accordance with another aspect of the invention, a bread tray and rotatable barrier for blocking the merchandiser window of the bread tray is provided. The barrier includes a first generally rectangular window blocking panel and a plurality of legs extending downward and inward at an angle from the window blocking panel. The legs include axle projections that enable the barrier to rotate or pivot from an in-use position blocking the merchandiser window to an un-used position where the barrier becomes part of the bottom wall of the tray. The tray includes an inset area for receiving the barrier when not in use. The inset area has a depth approximately equal to a thickness of the barrier so that the barrier is flush with the remaining portion of the bottom wall when the barrier is in a down position and the outer surface of the barrier becomes part of the upper surface of the bottom wall. The tray also includes a plurality of flanges or similar structure having openings for receiving the axle projections on the legs of the barrier. One or more of the flanges can include an upper locking rib for keeping the barrier in place (i.e., upright) when in the in-use position. The flanges can also include a ledge for supporting a lower edge of the window blocking panel.

Other features and advantages of the invention will be apparent from the following specification taken in conjunction with the following Figures.

### BRIEF DESCRIPTION OF THE DRAWINGS

To understand the present invention, it will now be described by way of example, with reference to the accompanying drawings in which:

FIG. 1 is a perspective view of a bread tray with a merchandiser window in a front wall of the tray;

FIG. 2 is a perspective view of a bread tray with a barrier covering the merchandiser window in accordance with one aspect of the present invention;

FIG. 3 is a is a perspective view of a bread tray with a barrier covering the merchandiser window in accordance with another aspect of the present invention;

FIG. 4 is a is a perspective view of a bread tray with a barrier covering the merchandiser window in accordance with yet another aspect of the present invention;

FIG. 5 is an outer perspective view of the barrier of FIG. 2;

FIG. 6 is a side perspective view of the barrier of FIG. 5;

FIG. 7 is an interior perspective view of the barrier of FIG. 5;

FIG. 8 is an outer perspective view of the barrier of FIG. 3;

FIG. 9 is an inner perspective view of the barrier of FIG. 8;

FIG. 10 is a lower perspective view of the barrier of FIG. 8;

FIG. 11 is an outer perspective view of the barrier of FIG. 4;

FIG. 12 is an inner perspective view of the barrier of FIG. 11;

FIG. 13 is a side perspective view of the barrier of FIG. 11;

FIG. 14 is a cross-sectional view of the bread tray and barrier of FIG. 2;

FIG. 15 is a cross-sectional view of the bread tray and barrier of FIG. 4

FIG. 16 is a is a perspective view of a bread tray with a pivotable barrier covering the merchandiser window in accordance with another aspect of the present invention;

FIG. 17 is a is a perspective view of a bread tray with the pivotable barrier of FIG. 16 in a down position;

FIG. 18 is a perspective view of the bread tray of FIG. 16 without the pivotable barrier;

FIG. 19 is an outer perspective view of the pivotable barrier of FIG. 16 without the tray;

FIG. 20 is an inner perspective view of the pivotable barrier of FIG. 19;

FIG. 21 is an enlarged perspective view of the pivotable barrier in an upright position;

FIG. 22 is an enlarged perspective view of the pivotable barrier in a down position;

FIG. 23 is a cross-sectional enlarged perspective view of the pivotable barrier of FIG. 21;

FIG. 24 is a cross-sectional enlarged perspective view of the pivotable barrier of FIG. 22; and,

FIG. 25 is another cross-sectional enlarged perspective view of the pivotable barrier of FIG. 21.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

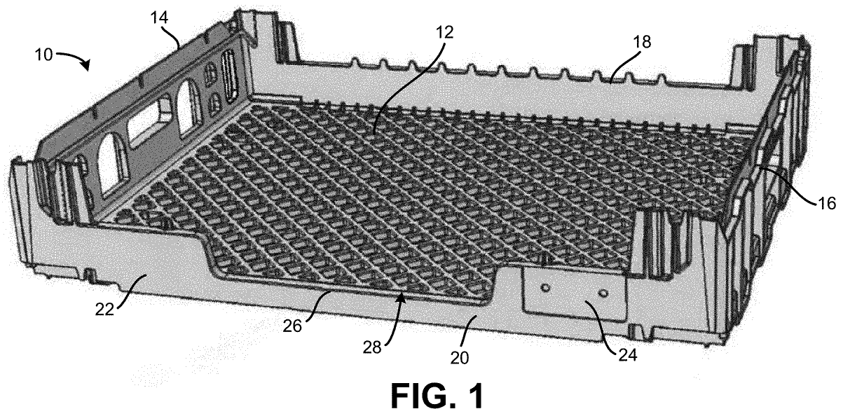

As illustrated in FIG. 1, a bread tray 10 used to transport bread and other similar products, typically includes a rectangular bottom wall having an upper surface 12, a first side wall 14 extending upward from a first side of the bottom surface 12, a second side wall 16 extending upward from a second side of the bottom surface 12, and a back wall 18 extending upward from a back side of the bottom surface 12. In the front of the tray 12 a front wall 20 has a first portion 22 extending partway from the first side wall 14, and a second portion 24 extending partway from the second side wall 16. The first portion 22 and the second portion 24 have a first height. A middle portion 26 of the front wall 20 extends between the first portion 22 and the second portion 24. The middle portion 26 has a height significantly less than the first height of the first portion 22 and the second portion 24. A merchandiser window 28 is defined above the middle portion 26 of the front wall 20.

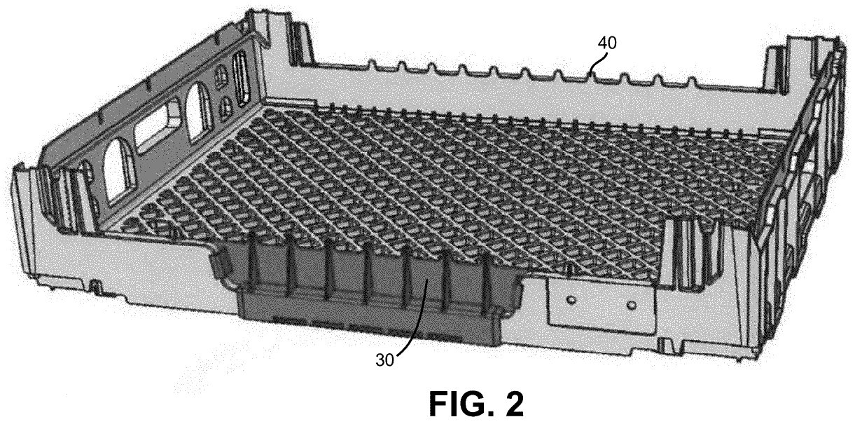

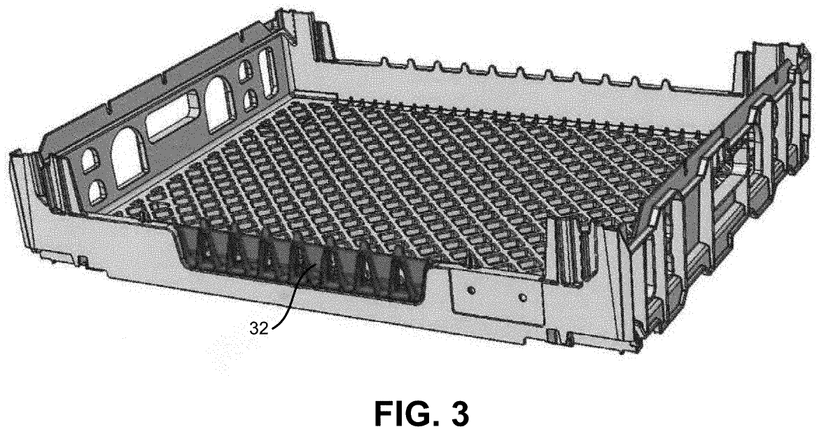

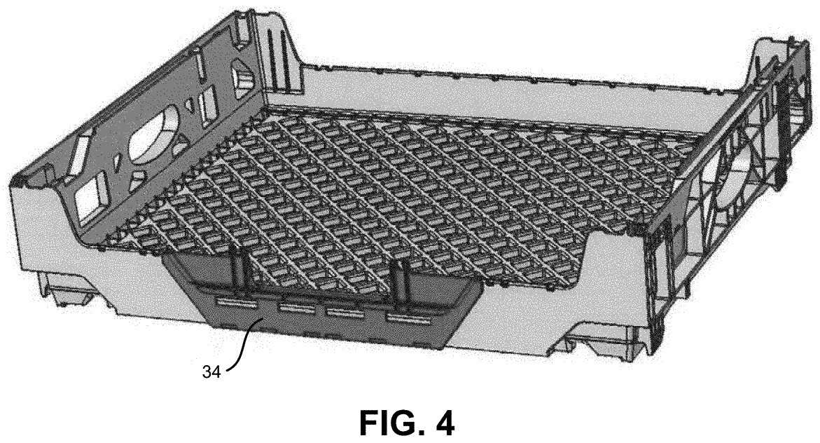

FIG. 2 shows a first barrier 30 that can be used to block the merchandiser window 28 of the tray 10. A second barrier 32 is shown in FIG. 3 and a third barrier 34 is shown in FIG. 4. Each of the barriers 30, 32, 34 can be made from a reusable material such as an injection molded plastic. Other similar materials can also be used.

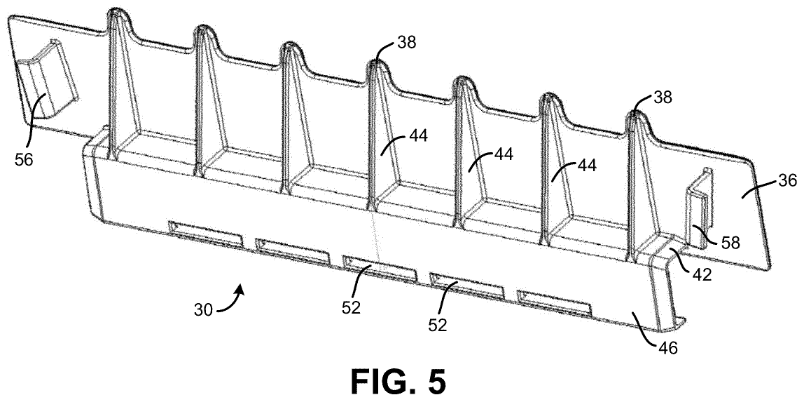

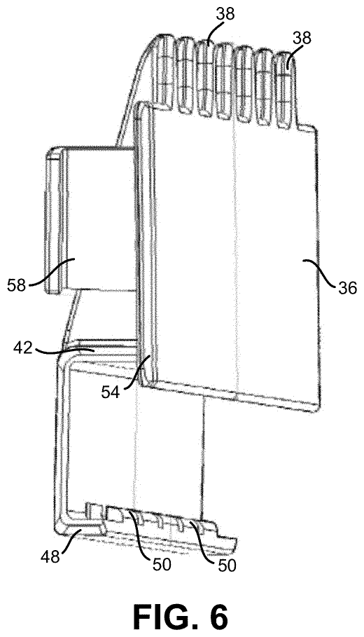

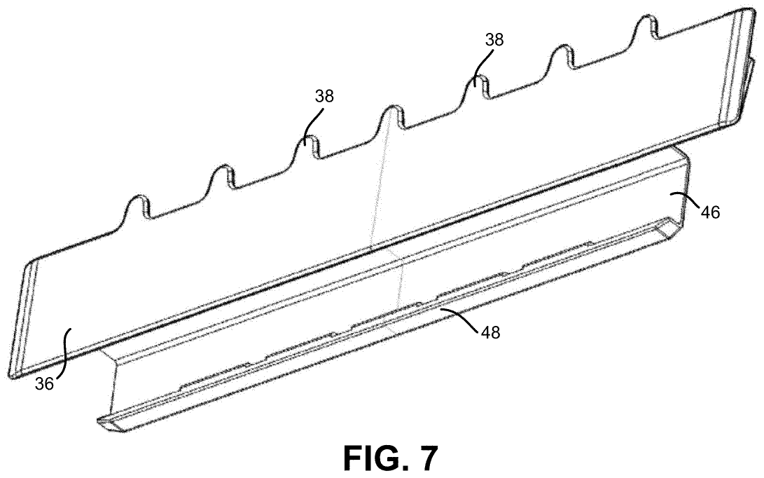

Referring to FIGS. 5-7, the barrier 30 of FIG. 2 includes a generally rectangular window blocking panel 36 sized to fit across the merchandiser window 28 of the bread tray 10. The panel 36 includes a plurality of upwardly extending protrusion 38 along a top edge. The protrusions 38 resemble upwardly extending protrusions 40 that are sometimes provided along the back wall 18 of the tray 10.

A horizontal ledge 42 extends outward from an exterior surface of the panel 36 proximate a lower portion of the panel 36. A plurality of triangular flanges or ribs 44 extend upward from a top surface of the ledge 42 to the top of the protrusions 38. The ledge 42 is designed to rest on a top edge of the middle portion 26 of the front wall 20 when secured to the tray 10.

A first hook portion having a generally rectangular panel 46 extends downward from an outer edge of the ledge 42. A horizontal portion 48 extends inwardly from a bottom edge of the panel 46 and a plurality of spaced protrusions 50 extend upward from an internal edge of the horizontal portion 48. The panel 46 includes a plurality of rectangular openings 52 proximate the bottom edge of the panel 46. The first hook portion is designed to span the middle portion 26 of the front wall 20 and hook around a lower edge of the wall 20. The first hook portion is shown as a single integral piece, however, this portion can be divided into two or more spaced apart portions.

A lower portion 54 of the window blocking panel 36 that extends below the ledge 42 forms a second hook portion. The second hook portion engages an upper, interior portion of the middle portion 26 of the front wall 20 if the tray 10.

The barrier 30 also includes a first L-shaped side bracket 56 (from a top view looking downward) and a second L-shaped side bracket 58 extending outward from an exterior surface of the window blocking panel 36. The first and second brackets 56, 58 each engage a side edge of the first and second portions 22, 24 of the front wall 20, respectively.

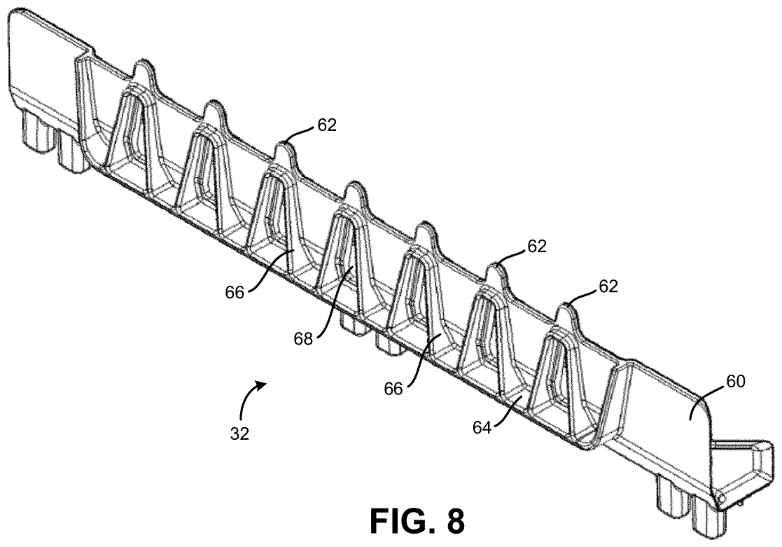

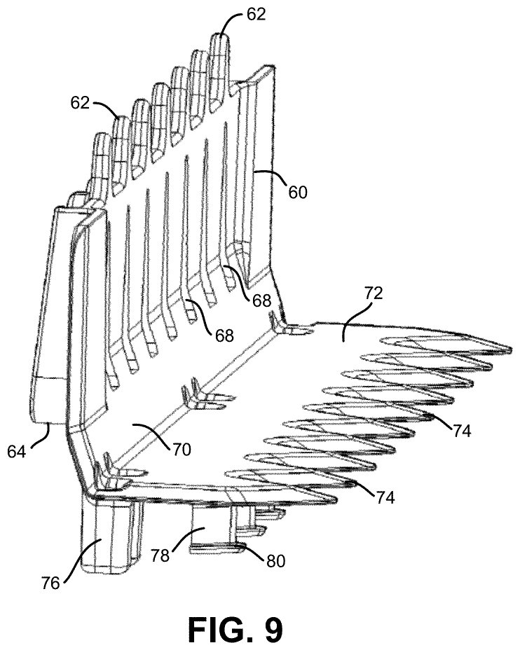

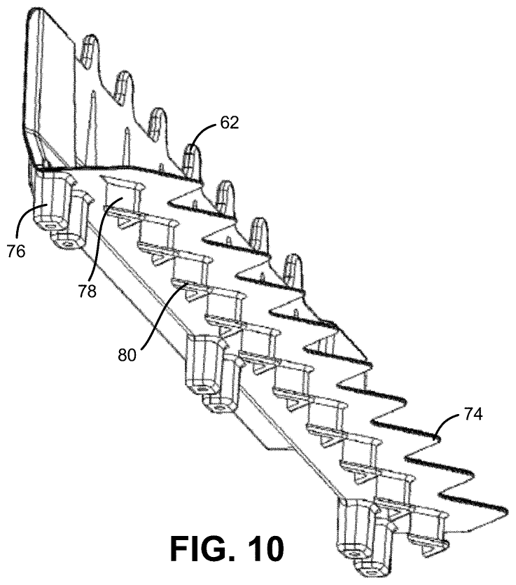

Referring to FIGS. 8-10, the barrier 32 of FIG. 3 includes a generally rectangular window blocking panel 60 with a plurality of protrusions 62 extending upward from a top edge of the window blocking panel 60. A horizontal ledge 64 extends outward from an exterior side of the window blocking panel 60. The horizontal ledge 64 is designed to rest on an upper edge of the middle portion 26 of the front wall 20 of the bread tray 10. A plurality of flanges 66 extend outward from the exterior side of the window blocking panel 60. A corresponding plurality of openings 68 align with flanges 66.

A transition portion 70 extends below the window blocking panel 60 to a horizontal panel 72 extending inward. A plurality of protrusions 74 extend inward from an end of the horizontal panel 72.

The barrier 32 includes a plurality of legs 76 that extend downward from the horizontal panel 72 where it connects to the transition portion 70, and a plurality of L-shaped segments 78 that extend downward from a mid-portion of the horizontal panel 72. The L-shaped segments include a lip 80 at a lower end. The legs 76 and L-shaped segments 78 are used to connect the barrier 32 to the bottom surface 12 of the bread tray 10. The bottom surface 12 of the tray 10 has a lattice structure with a plurality of openings which allow for insertion of the legs 76 and L-shaped segments 78.

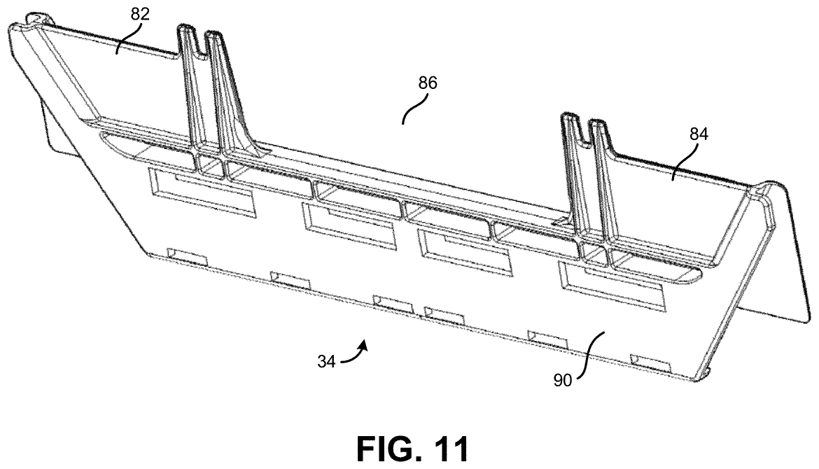

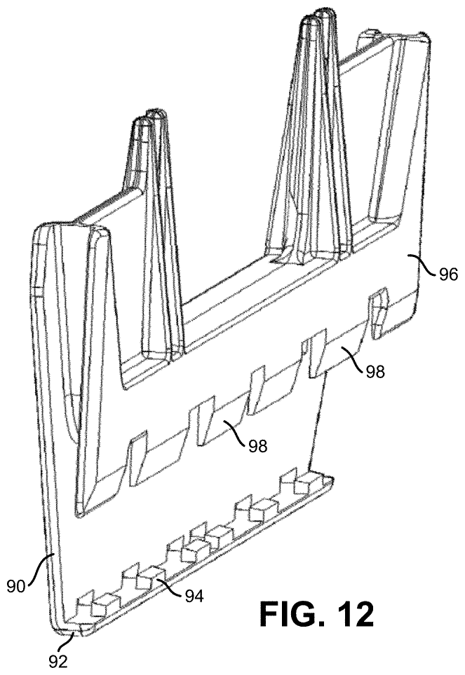

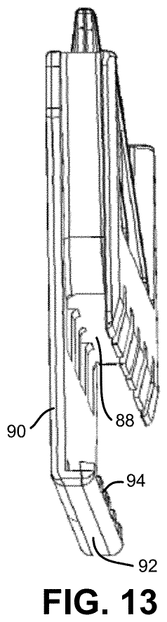

Referring to FIGS. 11-13, the barrier 34 of FIG. 4 includes a first window blocking panel 82 and a second window blocking panel 84 spaced from the first window blocking panel 82 by a gap 86. This version of the barrier, in effect, creates a smaller merchandiser window in the gap 86.

The barrier 34 includes a horizontal ledge 88 directly below the first window blocking panel 82, second window blocking panel 84 and gap 86. The horizontal ledge 88 is designed to rest on an upper edge of the middle portion 26 of the front wall 20 of the bread tray 10.

Similar to the barrier 30 of FIG. 2, the barrier 34 of FIG. 4 includes a first hook portion having a trapezoidal shaped panel 90 extending downward from an exterior edge of the ledge 88. A horizontal segment 92 extends inwardly from a bottom edge of the panel 90. The horizontal segment 92 includes a plurality of protrusions 94 extending upward. The first hook portion is designed to engage a lower edge of the front wall 20 of the bread tray 10.

A second hook portion includes a panel 96 extending downward from an interior edge of the ledge 88. The panel includes a plurality of downwardly extending protrusions 98. The second hook portion is designed to engage a top portion of the front wall 20.

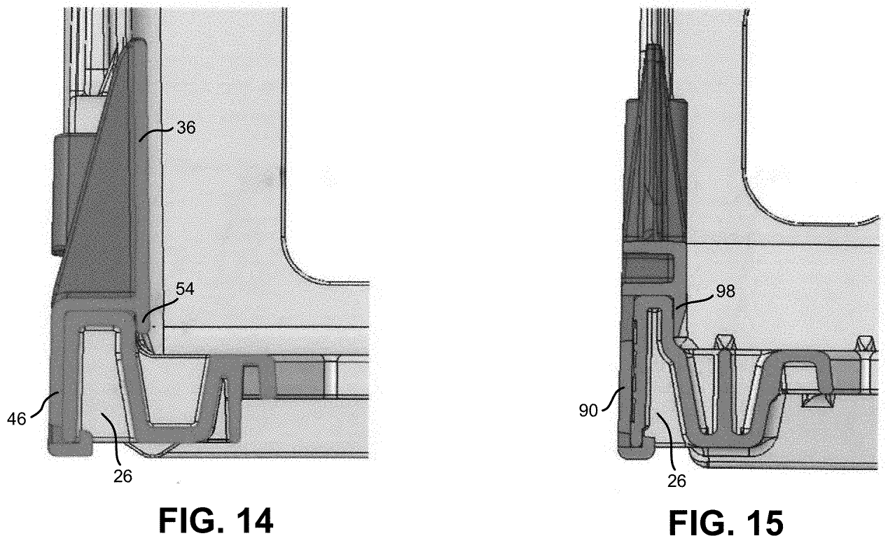

FIG. 14 illustrates how the barrier 30 hooks onto the front wall 20 of the bread tray 10 to secure the window blocking panel 36 in the proper location. Similarly, FIG. 15 illustrates the barrier 34 connected to the front wall 20 of the bread tray 10.

In some embodiments, the barrier can include a hinge component (e.g., by forming the barrier into multiple parts having a hinge system, or keeping the barrier as a single integral structure and providing a flexible or bendable portion). The hinge can allow a user to temporarily move the window blocking portion of the barrier out of the way to provide access to the tray when multiple trays are stacked on each other.

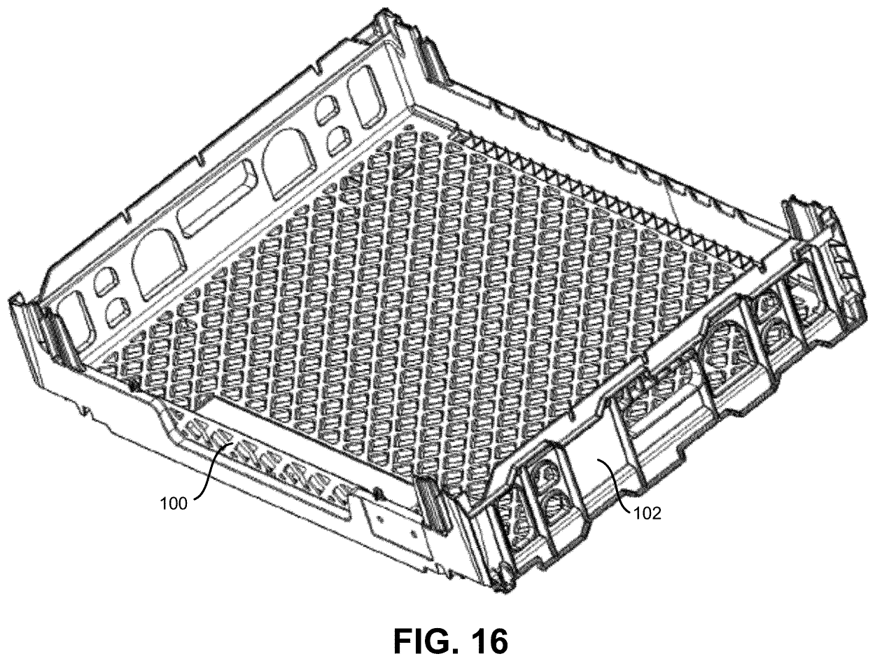

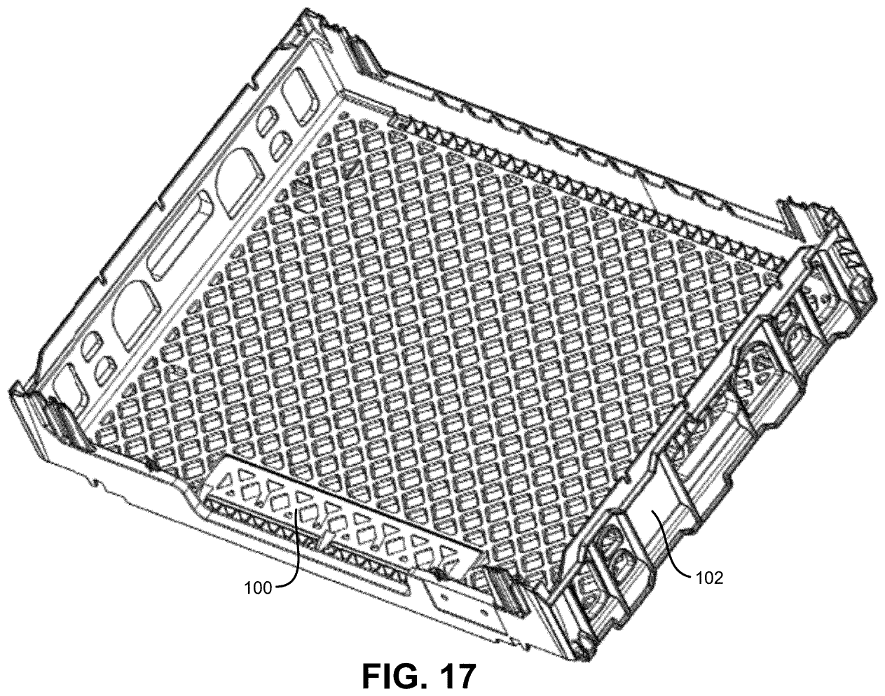

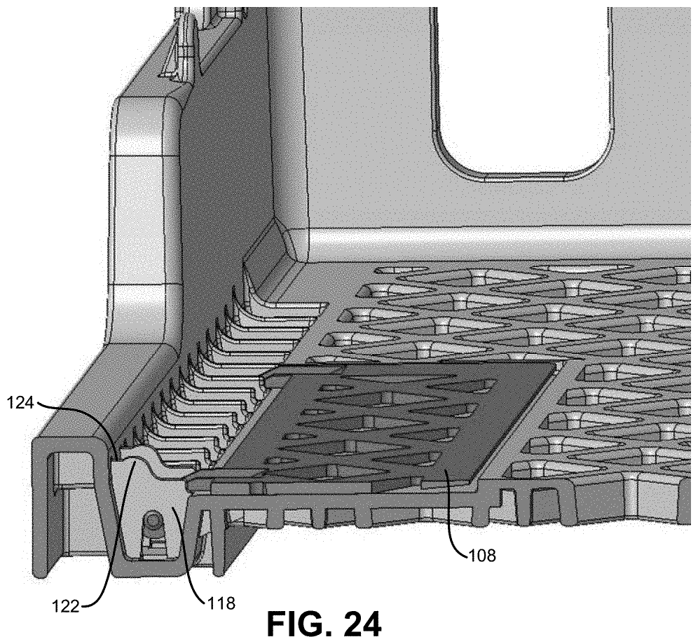

In another aspect of the invention shown in FIGS. 16-24, a barrier 100 can be rotatably or pivotably connected to the tray 102. When rotated upward, the barrier 100 blocks the merchandiser window, and when rotated downward the barrier 100 is flush with the bottom wall 104 and the merchandiser window is open.

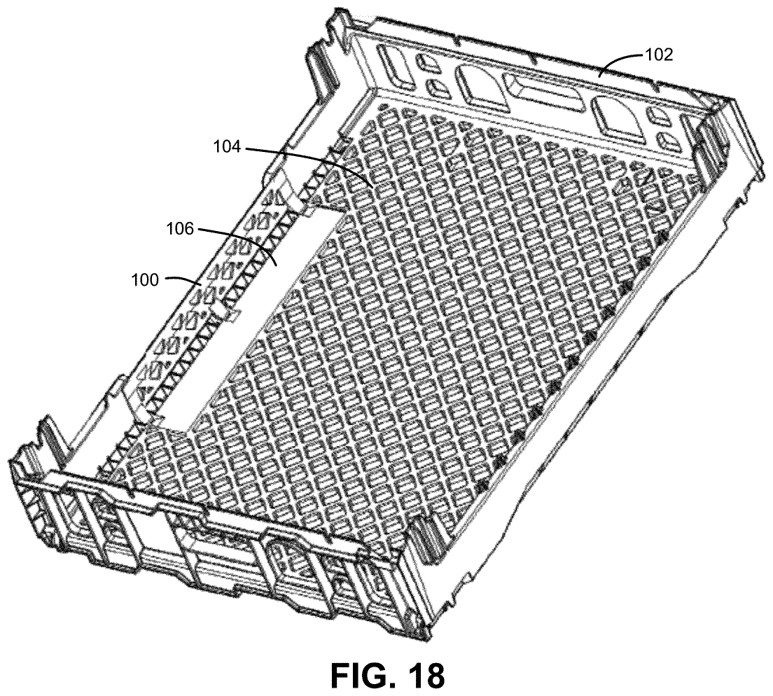

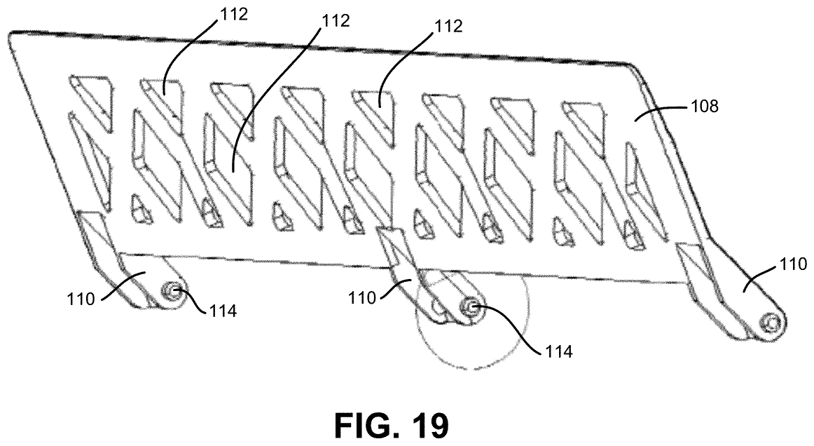

As more clearly shown in FIG. 18, a bottom wall 104 of the tray 102 includes an area 106 adjacent the portion of the front wall of the tray having the merchandiser window, that is inset from the remainder of the bottom wall 104. This inset area 106 allows the barrier 100 to form a part of the upper surface of the bottom wall 104 when it is pivoted into the down position.

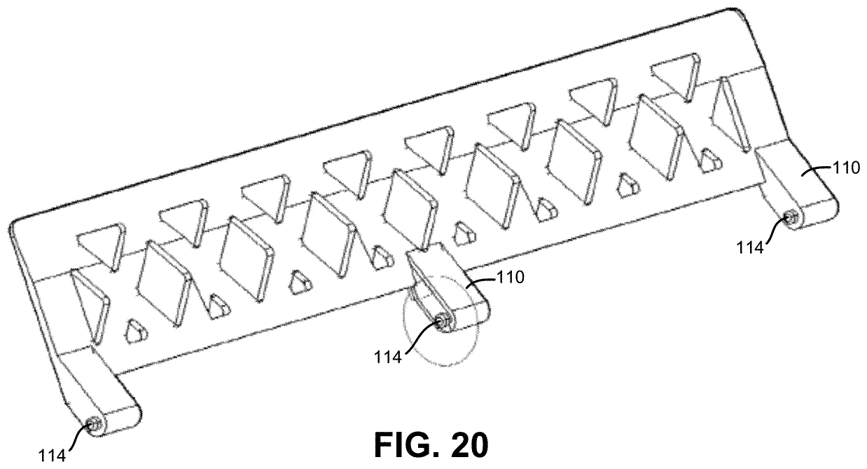

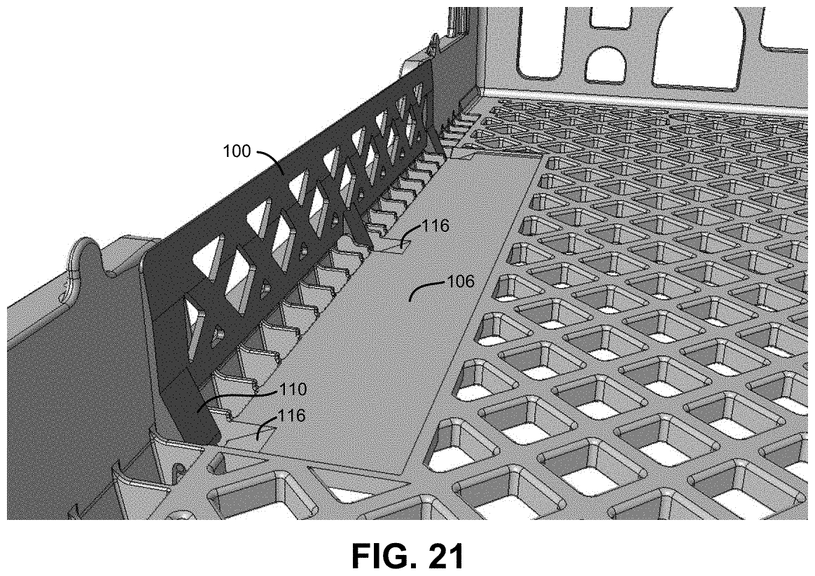

FIGS. 19 and 20 shown the barrier 100 without the tray 102. The barrier 100 includes a generally rectangular window blocking portion 108 and a plurality of legs 110 extending downward from the window blocking portion 108. The window blocking portion 108 includes a plurality of openings 112 through which one can see if there are products in the tray.

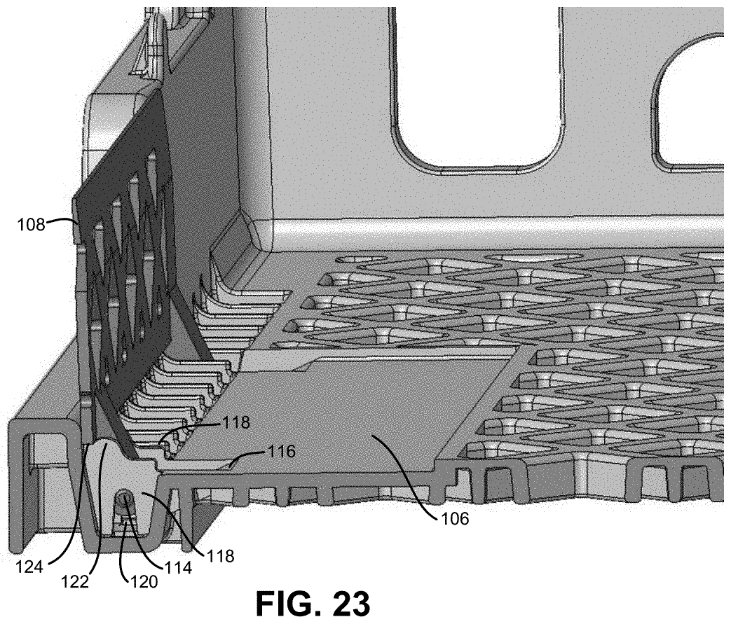

The legs 110 are used to connect the barrier 100 to the tray 102 and to enable it to rotate or pivot from an upright position blocking the merchandiser's window to a down position leaving the merchandiser's window open. Each of the legs includes axle projections 114 on either side that fit in openings 120 in flanges 118 on the tray 102 (see e.g., FIG. 23). Alternatively, the legs 110 of the barrier 100 could be formed with openings for receiving axle projections on the tray (or other similar arrangements—e.g., a separate, single axle going through both the flanges on the tray and openings in the legs).

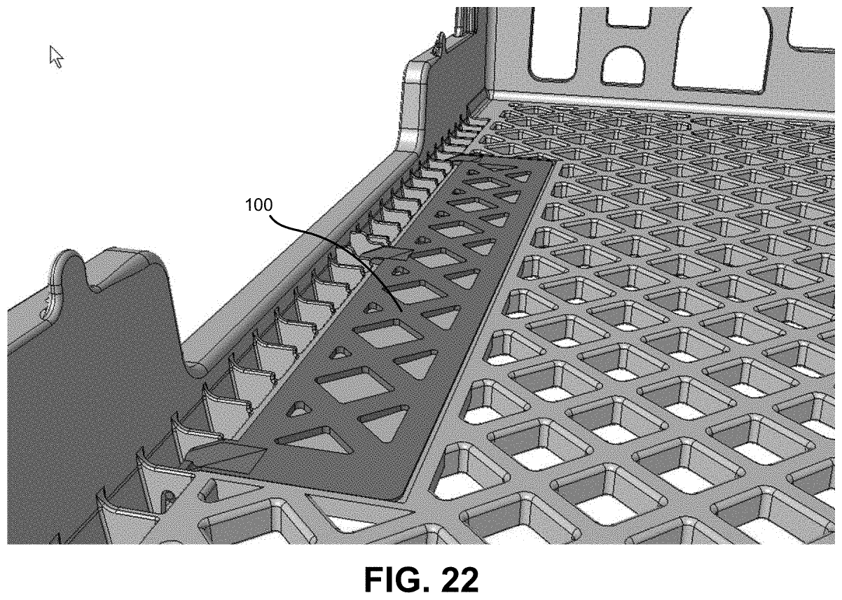

FIG. 21 provides an enlarged view of the barrier 100 in an upright position. The tray 102 includes an area 106 which is inset in the bottom wall 104. When the barrier is rotated to a down position, as shown in FIG. 22, it fits in the inset area 106 such that its outer surface is flush with the remainder of the top surface of the bottom wall 104. The inset area 106 includes angled ramps 116 for receiving the legs 110 of the barrier 100. The legs 110 extend downward and outward from the window blocking portion 108 at an angle which allows them to fit in the angled ramps 116.

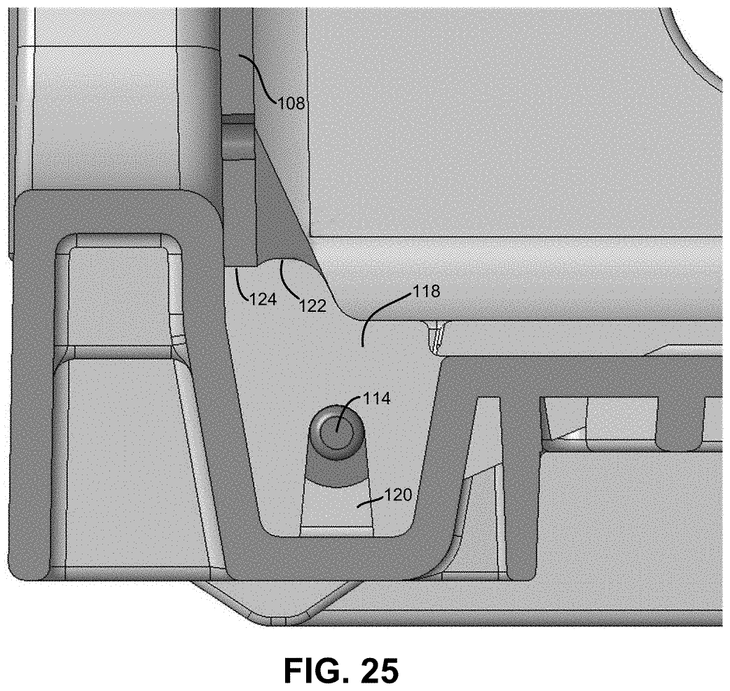

As shown in cross-section in FIGS. 23, 24 and 25, each of the legs 110 is positioned between two flanges or ribs 118 formed in the bottom wall proximate the front wall of the tray 102. The axle projections 114 fit into slots or openings 120 in the flanges 118 which allow the projections 114 to rotate. At least one (and possibly more) of the flanges 118 includes an upper locking projection or rib 122. The locking rib 122 keeps the barrier in place during use. The bottom edge of the window blocking portion 108 rests on a ledge portion 124 of the flange on one side of the locking rib 122.

In the embodiment of FIGS. 16-25, the legs 110 of the barrier 100 are utilized as the connector of the barrier 100 to the tray 102. The axle projections 114 secure the legs 110 to the flanges 118 in the tray 102.

Additionally, the tray 102 of FIGS. 16-25 is modified as described and shown herein from a standard bread tray. The modifications enable the barrier 100 to be securely connected to the tray and rotatable from an in-use position to an un-used position. The modifications include the bottom flanges 118 having openings for the axle projections 114 on the legs 110 of the barrier 100, the locking ribs 122 on one or more of the flanges 118 and the ledge 124. The inset area 106 and ramps 116 are further modifications to the standard bread tray.

Many modifications and variations of the present invention are possible in light of the above teachings. It is, therefore, to be understood within the scope of the appended claims the invention may be protected otherwise than as specifically described.

We claim:

1. A bread tray merchandiser window barrier comprising:
a first plastic panel configured to block at least a portion of a window of a bread tray; and,
a connector extending from the first panel to enable connection of the first panel to the bread tray.

2. The bread tray merchandiser window barrier of claim 1 wherein the connector includes a first lower hook extending downward from the first panel to engage a lower edge of a front wall of the bread tray.

3. The bread tray merchandiser window barrier of claim 2 wherein the connector includes a second lower hook spaced from the first hook extending downward from the first panel to engage the lower edge of the front wall of the bread tray.

4. The bread tray merchandiser window barrier of claim 3 wherein the connector includes a first interior hook extending outward from a first side of the first panel to engage an upper edge of the front wall of the bread tray.

5. The bread tray merchandiser window barrier of claim 4 wherein the connector includes a second interior hook spaced from the first interior hook extending outward from the first side of the first panel to engage the upper edge of the front wall of the bread tray.

6. The bread tray merchandiser window barrier of claim 1 wherein the first panel spans from a first side of the merchandizer window of the bread tray to a second side of the merchandizer window of the bread tray.

7. The bread tray merchandiser window barrier of claim 6 wherein the connector includes a plurality of legs having axle projections extending downward from the first plastic panel.

8. The bread tray merchandiser window barrier of claim 2 including a ledge extending outward from a lower edge of the first panel configured to rest on an upper edge of the front wall of the bread tray.

9. The bread tray merchandiser window barrier of claim 1 wherein the connector includes a plurality of protrusions extending downward from the first panel for engagement with a bottom surface of the bread tray.

10. The bread tray merchandiser window barrier of claim 1 wherein the first panel extends part way from a first side of the merchandiser window of the bread tray toward a second side of the merchandiser window of the bread tray.

11. The bread tray merchandiser window barrier of claim 10 further comprising a second panel wherein a portion of the connector extends downward from the second panel.

12. The bread tray merchandiser window barrier of claim 11 wherein the second panel extends part way from the second side of the merchandiser window of the bread tray toward the first side of the merchandiser window of the bread tray.

13. The bread tray merchandiser window barrier of claim 12 comprising a gap between an end of the first panel and an end of the second panel.

14. The bread tray merchandiser window barrier of claim 1 wherein the barrier is formed from an injection molded plastic.

15. The bread tray merchandiser window barrier of claim 1 comprising a hinge element between the first panel and the connector.

16. The bread tray merchandiser window barrier of claim 1 comprising a first side wall clasp extending outward on a first side portion of the first panel and a second side wall clasp extending outward on a second side portion of the first panel.

17. A bread tray merchandiser window barrier comprising
a horizontal ledge;
a generally rectangular plastic panel extending upward from the horizontal ledge;
a first hook portion extending downward from a first edge of the horizontal ledge wherein the first hook portion is configured to engage a lower edge of a front wall of a bread tray;
a second hook portion extending downward from a second edge of the horizontal ledge wherein the second hook portion is configured to engage an upper edge of the front wall of the bread tray.

18. The bread tray merchandiser window barrier of claim 17 further comprising a plurality of flanges extending outward from a first side surface of the rectangular panel.

19. The bread tray merchandiser window barrier of claim 17 further comprising a centrally located gap portion in the rectangular panel.

20. The bread tray merchandiser window barrier of claim 17 comprising a first side wall clasp extending outward on a first side portion of the rectangular panel and a second side wall clasp extending outward on a second side portion of the rectangular panel.
